(19) United States
(12) Patent Application Publication
(10) Pub. No.: US 2016/0100641 A1
(43) Pub. Date: Apr. 14, 2016

(54) Clothing Having Audio And Visual Capabilities

(71) Applicant: Evelyn Payne, Watertown, TN (US)

(72) Inventor: Evelyn Payne, Watertown, TN (US)

(21) Appl. No.: 14/512,433

(22) Filed: Oct. 12, 2014

(51) Int. Cl. A41D 27/00; G06F 3/16; F21V 33/00; H04R 1/02; A41D 3/02; A41D 27/08

(52) U.S. Cl. CPC A41D 27/00; A41D 3/02; A41D 27/085; F21V 33/0008; H04R 1/028; G06F 3/165; F21W 2121/06

(57) ABSTRACT

A jacket that is configured to provide a visual effect and a sound effect. The jacket includes a body having a pair of sleeves and a hood. A plurality of removable light chains are secured to the body in an ornamental orientation. The jacket further includes at least one audio speaker that is operable to produce sound effects such as play music. A controller is disposed within the body of the jacket and is operable to provide control of the jacket and the production of the visual effect and the sound effects. The controller is embodied as a conventional controller with manual interfaces or is embodied such that it is wirelessly coupled with a software application stored on an external device such as a smartphone. A power supply is included to provide the necessary power to operate the jacket.

### PRIORITY UNDER 35 U.S.C Section 119(e) & 37 C.F.R. Section 1.78

This nonprovisional application claims priority based upon the following prior U.S. Provisional Patent Application entitled: Jacket, Application No.: 62/035,958 filed Aug. 11, 2014, in the name of Evelyn Payne, which is hereby incorporated by reference for all purposes.

### FIELD OF THE INVENTION

The present invention relates generally to novelty clothing, more specifically but not by way of limitation but a jacket that includes the ability to play a plurality of audio data files and further includes decorative lighting.

### BACKGROUND

Millions of people around the world celebrate Christmas. Christmas is one of the largest holidays of the year in terms of participation. During the Christmas season people will decorate their houses, throw parties and engage in other festive activities. Music and lights will also be used in displays around the community as a part of the celebration of the birth of Christ.

During the holiday season people will also wear decorative, or themed, attire. Holiday sweaters and similar articles of clothing are very popular amongst all ages. While some existing technology does provide lighted holiday sweaters, currently no article of clothing is available that provides lights and holiday music wherein elements required to produce the lights and holiday music are integrated into an article of clothing such as but not limited to a jacket.

Accordingly there is a need for a holiday themed article of clothing that includes integrated lights and audio producing capabilities.

### SUMMARY OF THE INVENTION

It is the object of the present invention to provide an article of clothing wherein the article of clothing is operable to produce visual and audial effects.

Another object of the present invention is to provide an article of clothing operable to produce visual and audial effects that is holiday themed.

A further object of the present invention is to provide a holiday themed jacket operable to provide audial and visual effects wherein the visual effects are produced utilizing detachable lights.

An additional object of the present invention is to provide an article of clothing that is holiday themed wherein the clothing is configured to provide visual and audial effects that includes a controller operable to provide a user interface to control the article of clothing.

Yet a further object of the present invention is to provide an article of clothing that is holiday themed wherein the controller is configured to be integrated into the system or an application on a smartphone.

Still another object of the present invention is to provide an article of clothing that is holiday themed wherein the article of clothing is operable to produce visual and audial effects that is cost effective.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is front view of an embodiment of the present invention; and

FIG. 2 is a block diagram of the components of the present invention; and

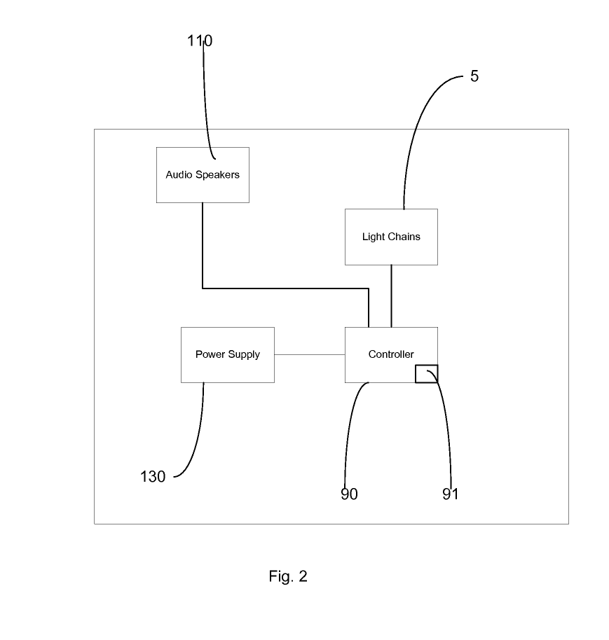

FIG. 3 is a flow chart of the method of use of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a jacket 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

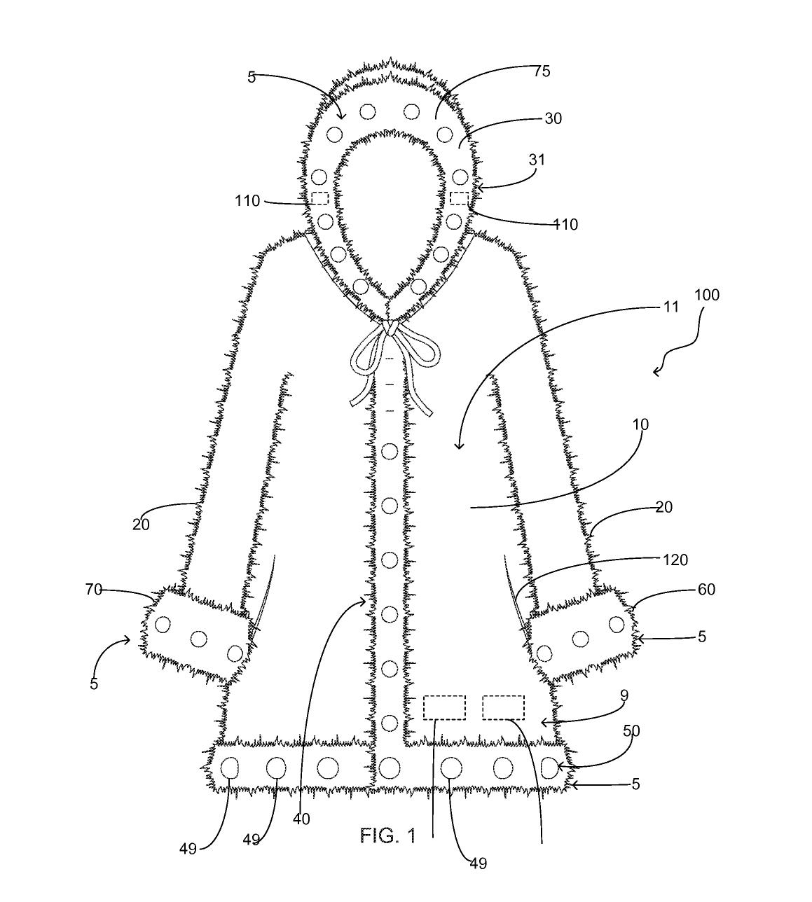

Referring in particular to FIG. 1 herein, the jacket 100 is illustrated therein in its preferred embodiment. The jacket 100 is conventional in its exterior construction having a body 10 with an integrated sleeves 20 and hood 30. The jacket 100 is manufactured from a suitable durable material such as but not limited to cotton. The jacket 100 includes a seam 40 that provides a means to divide the body 10 along the front portion 11 so as to facilitate the donning of the jacket 100 by a user. While the preferred embodiment described herein is a jacket 100, it is contemplated within the scope of the present invention that the jacket 100 could be constructed as a sweatshirt or other similar article of clothing.

The jacket 100 further includes a lower perimeter light chain 50 proximate the bottom 9 of the body 10. The lower perimeter light chain 50 is manufactured from a plurality of light emitting sources such as but not limited to light emitting diodes. The lower perimeter light chain 50 is surroundably mounted to the body 10 utilizing suitable durable techniques. The lower perimeter light chain 50 is further configured to be releasably secured to the body 10 in order to be removed for cleaning of the jacket 100. The lower perimeter light chain 50 is operably coupled to the controller 90. As is further discussed herein the controller 90 provides operation of the lights 49 within the lower perimeter light chain 50.

A second light chain 60 and third light chain 70 are surroundably mounted each opposing sleeve 20 proximate the ends 21 thereof. The second light chain 60 and third light chain 70 are operably coupled to the controller 90 and are controlled therewith. A fourth light chain 75 is present along the edge 31 of the hood 30. The fourth light chain 75 is similar in construction to the second light chain 60 and third light chain 70 and is also operably coupled to the controller 90. While a lower perimeter light chain 50, second light chain 60, third light chain 70 and fourth light chain 75 have been disclosed herein in the preferred embodiment of the jacket 100, it is contemplated within the scope of the present invention that the jacket 100 cold be constructed with various quantities of light chains having as few as one or more than four. In one preferred embodiment, the light chains 5 are secured within a decorative element such as but not limited to fur and the light chains 5 are releasably secured to the jacket 100.

Secured within the hood 30 utilizing suitable durable techniques are audio speakers 110. The audio speakers 110 are conventional audio speakers that are operable to emit audio sounds such as but not limited to music. The audio speakers 110 are operably coupled to the controller 90 and function to provide sound to a wearer of the jacket 100 and/or to individuals proximate thereto. While two audio speakers 110 have been illustrated herein, it is contemplated within the scope of the present invention that the jacket 100 could include various quantities of audio speakers 100.

The controller 90 includes the necessary electronics to store, receive, transmit and manipulate data so as to facilitate the operation of the jacket 100. The controller 90 is mounted within the jacket 100 such that it is concealed and it is contemplated within the scope of the present invention that the controller 90 could be mounted such that the controller 90 is accessible to a user via pocket 120. The controller 90 is contemplated to have a first embodiment and a second embodiment. In its first embodiment, the controller 90 is a conventional controller having a plurality of switches and/or button that facilitate the activation of the light chains 5 and sound to be broadcast via the audio speakers 130. In its second embodiment, the controller 90 is a software application downloaded to a conventional smartphone or similar device wherein the software application communicates wirelessly to the transceiver 91 integrated in the controller. The transceiver 91 is configured to communicate to a smartphone having a software application via Bluetooth or other suitable technique. In its second embodiment, the controller 90 is programmed via the software application to operate the audio and visual effects provided by the light chains 5 and audio speakers 110. The controller 90 is operably coupled to the aforementioned light chains and the audio speakers 110 utilizing conventional techniques such as but not limited to wires.

A power supply 130 is secured proximate the controller 90 and functions to provide the necessary power to operate the jacket 100. While no particular power supply 130 is required, good results have been achieved utilizing a lithium ion battery.

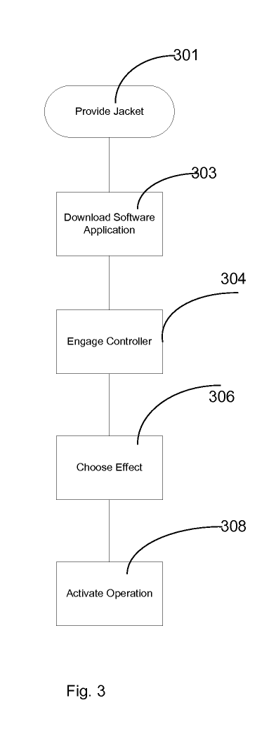

Referring in particular to FIG. 3, a flowchart of the operation of the jacket 100 is summarized therein. In step 301, a jacket 100 is provided to a user typically through a conventional channel of commerce such as but not limited to store. Subsequent to step 301, the user will be directed to the appropriate resource to download the software application operable to facilitate communication with the controller 90, in step 303. Step 304, the user will engage the software application interface to program the jacket 100 to display either a visual effect and/or a sound effect via the light chains 5 or audio speakers 110 respectively. The controller 90 is further operable to provide simultaneous operation of the lights chains 5 and audio speakers 110. In step 306, the user will engage the controller 90 to choose the desired effect to produce. Step 308, the user will place the jacket 100 in its operational mode wherein the jacket 100 will display both its programmed audio and visual effects.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A jacket configured to display a entertainment effects comprising:
a body, said body having a first sleeve and a second sleeve, said body being constructed to surroundably mount the torso of a human;
a controller, said controller being secured within said body, said controller having the necessary electronics to store, receive, transmit and manipulate data, said controller operable to control a first effect and a second effect produced by the jacket;
a power supply, said power supply being secured within said body, said power supply operably coupled to said controller;
at least one light chain, said at least one light chain secured to said body, said at least one light chain consisting of a plurality of lights, said at least one light chain being operably coupled to said controller;
at least one audio speaker, said at least one audio speaker secured to said body, said at least one audio speaker operably coupled to said controller; and
wherein said controller is operable to provide a first mode and a second mode of the jacket, wherein in said first mode the jacket provides a first entertainment effect and wherein in said second mode, the jacket is operable to provide a second entertainment effect.

2. The jacket as recited in claim 1, wherein said first entertainment effect is a visual effect, said first entertainment effect being a flashing of said at least one light chain.

3. The jacket as recited in claim 2, wherein said second entertainment effect is a sound effect, said second entertainment effect being a production of sound from said at least one audio speaker.

4. The jacket as recited in claim 3, wherein the jacket further includes a hood, said hood having a perimeter edge, said hood having a second light chain secured to said perimeter edge.

5. The jacket as recited in claim 4, and further including a third light chain and a fourth light chain, said third light chain and said fourth light chain being secured to said first sleeve and said second sleeve.

6. The jacket as recited in claim 1, wherein said at least one light chain is releasably secured to said body.

7. The jacket as recited in claim 1, and further including a software application, said software application being stored on a conventional smartphone, said software application operably coupled to said controller.

8. A jacket configured to provide a visual effect and an audio effect comprising:
a body, said body having a first sleeve and a second sleeve, said body being constructed to surroundably mount the torso of a human, said body having a lower end and an upper end, said body further including a hood proximate said upper end;
a controller, said controller being secured within said body, said controller having the necessary electronics to store, receive, transmit and manipulate data, said controller operable to control the providing of the visual effect and the audio effect;
a power supply, said power supply being secured within said body, said power supply operably coupled to said controller;
a plurality light chains, said plurality light chains secured to said body, said plurality light chains consisting of a plurality of lights, said plurality of lights being light emitting diodes, said plurality of light chains being operably coupled to said controller;
at least one audio speaker, said at least one audio speaker secured to said body, said at least one audio speaker operably coupled to said controller; and
wherein the jacket is operable in a first mode and a second mode, in said first mode the jacket is operable to produce visual effects utilizing said plurality of light chains and in said second mode the jacket is operable to produce sound effects via said at least one audio speaker.

9. The jacket as recited in claim 8, wherein the jacket includes a third mode, in said third mode the jacket is operable to simultaneously produce visual and audial effects.

10. The jacket as recited in claim 9, wherein said plurality of light chains are releasably secured to said body.

11. The jacket as recited in claim 10, wherein said controller further includes a transceiver, said transceiver configured to transmit and receive data signals.

12. The jacket as recited in claim 11, wherein the jacket further includes a software application interface, said software application interface being stored on a conventional smartphone, said software application interface operable to wirelessly communicate with said controller.

13. The jacket as recited in claim 12, wherein said at least one audio speaker is secured within said hood.

14. The jacket as recited in claim 13, wherein said power supply is a lithium ion battery.

15. A method of providing a first entertainment effect and a second entertainment effect with an article of clothing comprising the steps of:
providing a jacket, said jacket having a body, said body having a first sleeve and a second sleeve, said body being constructed to surroundably mount the torso of a human, said body having a lower end and an upper end, said body further including a hood proximate said upper end, said jacket further having a controller, said controller being secured within said body, said controller having the necessary electronics to store, receive, transmit and manipulate data, said controller operable to control the providing of the first entertainment effect and the second entertainment effect, said jacket further including a plurality light chains, said plurality light chains secured to said body, said plurality light chains consisting of a plurality of lights, said plurality of lights being light emitting diodes, said plurality of light chains being operably coupled to said controller, said jacket having at least one audio speaker, said at least one audio speaker secured to said body, said at least one audio speaker operably coupled to said controller;
downloading a software application, said software application being stored on a server accessible via the internet;
engaging said controller, said controller being configured to direct the jacket to provide the first entertainment effect and the second entertainment effect, said controller being engaged with the software application;
choosing an effect, wherein a user chooses to produce either the first entertainment effect, the second entertainment effect or a combination thereof;
activating the jacket, wherein in the step of activating the jacket the controller activates either the first entertainment effect or the second entertainment effect.

16. The method of providing a first entertainment effect and a second entertainment effect with an article of clothing as recited in claim 15, and further including providing a first entertainment effect, said providing a first entertainment effect being a visual effect, said visual effect being produced by said plurality of light chains.

17. The method of providing a first entertainment effect and a second entertainment effect with an article of clothing as recited in claim 15, and further including providing second entertainment effect, said providing a second entertainment effect being produced via said at least one audio speaker, said second entertainment effect being a song.
